(19) United States
(12) Patent Application Publication
(10) Pub. No.: US 2024/0092696 A1
(43) Pub. Date: Mar. 21, 2024

(54) USE OF A REACTIVE LIQUID APPLIED ROOF WATERPROOFING PRODUCT FOR PRODUCING A ROOFING MEMBRANE

(71) Applicant: Remmers GmbH, Löningen (DE)

(72) Inventors: Dennis Boesker, Lingen (DE); Kevin Willen, Dinklage (DE); Ralf Wilgen, Lindern (DE); Magnus Greiwe, Rheine (DE); Christiane Saalbach, Löningen (DE); Lukas Schrand, Molbergen (DE); Sebastian Kiehn, Löningen (DE); Jens Engel, Bramsche (DE)

(21) Appl. No.: 18/039,537

(22) PCT Filed: May 24, 2022
(86) PCT No.: PCT/DE2022/100396

§ 371 Date: May 31, 2023

(30) Foreign Application Priority Data
May 25, 2021 (DE) 10 2021 113 486.2
Aug. 31, 2021 (WO) PCT/EP2021/074048
Mar. 23, 2022 (DE) 10 2022 106 887.0

(51) Int. Cl. C04B 28/14; C04B 24/26; C04B 24/28

(52) U.S. Cl. CPC C04B 28/14; C04B 24/2611; C04B 24/2641; C04B 24/2676; C04B 24/282; C04B 2111/00586

(57) ABSTRACT

The invention relates to the use of a reactive liquid applied material for producing a roofing membrane, wherein the reactive liquid applied material has a liquid component and a powder component, wherein the powder component comprises a mineral binder system consisting of a plurality of mineral binders capable of forming an ettringite phase when combined, and wherein the liquid component comprises one or more aqueous polymer dispersions. According to the invention, the reactive material contains at least twice, preferably at least 2.5 times, in particular at least three times as much wt. % solids content of polymers as it does wt. % mineral binders, a proportion of a PU polymer is at most 30% of the solids content of polymers, relative to the total mass of the polymers, and at least one of the polymers used in the reactive roof waterproofing product has a Tg determined by DSC of less than −20° C., preferably less than −30° C.

### SUBJECT MATTER OF THE INVENTION

The invention relates to the use of a reactive liquid applied waterproofing product for producing a roofing membrane.

### PRIOR ART

Roof waterproofing protects the roofs of buildings from weather influences such as rain, snow, hail, but also UV radiation. Very high demands are made in terms of elasticity, UV stability, crack bridging ability, shock resistance, water resistance and pressing water stability.

Bituminous-based roofing membranes such as roofing felt and plastic-based roof waterproofing products such as EPDM, i.e. plastics based on ethylene, propylene and diene monomers, PUR, i.e. polyurethane systems or PMMA, i.e. plastics based on methyl methacrylate or polyaspartic systems, are known.

The current state of the art for sealing flat roofs is presented in DIN EN 18531, the Flat Roof Directive and ETAG 005.

In the following, ETAG 005 is always quoted in the version of the March 2004 revision. DIN EN 18531 is always quoted in the version of July 2017. The Flat Roof Directive is quoted in the version of the May 2019 revision.

Flat roofs are usually sealed using bituminous or polymeric coating materials. A distinction must be made between sheet material in the form of films or sheets, for example bitumen webs, plastic webs or TPO films, i.e. thermoplastic polyolefin films, and liquid-applied materials, which in turn can be subdivided into physically drying 1K materials and chemically curing polymers, e.g. with air moisture or other added components.

There is a risk of mechanical damage during transport and handling of sheet material on the construction site. In general, sheet materials also entail difficult handling for the processor, due on the one hand to the high weight of the rolls and on the other hand to the low flexibility of the sheets. In addition, the need for welding or bonding of the individual sheets is an inherent problem, which can lead to the formation of weak points in the seal. The above-mentioned poor processing properties also mean that it is difficult to use sheet materials on detail sections and connection points. For the application of bitumen sheets, there is also an increased risk of fire and combustion, as the welding of such sheets necessitates the use of gas burners, which can lead to significant physical stress on the processors, especially in summer temperatures and solar radiation.

The application of liquid plastics, hereinafter referred to as LPs, involves a particularly high amount of work, due to the need for several work steps, each with long drying times. LPs require various work steps to build up the required layer thickness, which significantly increases the effort required for sealing a structure. In addition, the LPs are highly sensitive to moisture when not cured. Contact with water almost always leads to the formation of defects, which then need to be corrected later. In addition, LPs typically have poor health tolerability or health-damaging properties, which can lead to sensitization of the processors. In addition to the inhalation risk for the processors, LPs often also have an extremely unpleasant odour, which can be perceived as a nuisance by residents and processors.

Single-component, bituminous emulsions, bituminous dispersions, polymer emulsions and polymer dispersions, on the other hand, exhibit slow physical drying, which is particularly detrimental at low temperatures and/or high humidity and on weakly absorbent to non-absorbent substrates.

WO 2012/038099 A1 discloses a use of coating agents based on one or more mineral binders, one or more polymers, one or more fillers, and optionally one or more additives for producing roof coatings, said coating agents containing at least 50 wt.-% polymers with respect to the dry weight of the polymers and the mineral binders, i.e. whereby more polymers than mineral binders are contained in relation to the dry weight. A disadvantage of this building material system is that it is not designed to be flexible and crack-bridging at low temperatures down to −20° C. or even down to −30° C., this is due, among other things, to an insufficiently low Tg of the polymers used. The examples disclose single-component systems, i.e. dry formulations based on vinyl acetate-ethylene copolymer or vinyl acetate-ethylene-vinyl ester terpolymer, to which water is added for the preparation of the coating.

DE 20 2005 015 351 U1 discloses a building material system with one or more components, comprising a comminuted rubber as a first constituent and as a second constituent a plastic dispersion with self-crosslinking properties, in addition to a cement and fillers. The polymer content is about 1.58 times the content of mineral binder. A disadvantage of this building material system is that it is not designed to be flexible and crack-bridging at low temperatures down to −20° C. or even down to −30° C.

WO 2017/190766 A1 discloses a 2K reactive building material comprising calcium sulfate, an ettringite former, an activator and a polymeric binder, wherein the polymer content in the examples disclosed therein is about 1.15 times the content of mineral binder.

WO 2015/199984 A1 discloses another reactive building material comprising calcium sulfate, an ettringite former and a polymeric binder, wherein the proportion of the polymers used in the examples disclosed therein is 1.45 times the proportion of mineral binder.

### OBJECT OF THE INVENTION

By contrast, the object of the present invention is to provide a water-resistant or waterproof, flexible, fast-curing and age-resistant roof roofing membrane.

The disadvantages described above are to be reduced and at the same time the advantages of the individual systems are to be combined in the form of a new type of roofing membrane.

The roofing membrane should be characterized by easy processability of the individual components, above all but not exclusively by simple processing without the need for burners, additional adhesives or welding agents, as well as application in as few steps as possible. In addition, the roofing membrane should have excellent properties for the formation of details and connection points.

In addition, the roofing membrane and the processing of its components should pose the lowest possible health burden for the processor and the environment, as well as facilitating environmentally friendly disposal. Furthermore, the roofing membrane should be characterized by a high moisture tolerance in the non-hardened state, an early rain resistance and a fast drying time, which is less dependent on the weather compared to the predominantly physically drying system.

In addition, the roofing membrane should facilitate individual design of the surface by means of pigmentation of the waterproofing as well as design by scattering various filler materials.

### DISCLOSURE OF THE INVENTION

According to a first aspect of the invention, a reactive liquid applied roof waterproofing product based on one or more mineral binders and one or more aqueous polymer dispersions is proposed.

In particular, the use of a reactive liquid applied roof waterproofing product for producing a roofing membrane is proposed, the reactive liquid applied roof waterproofing product having a liquid component and a powder component, the powder component comprising a mineral binder system capable of forming an ettringite phase, consisting of one or more mineral binders and therefore having the ability to rapidly bind water, and the liquid component comprising one or more aqueous polymer dispersions.

It is provided that the reactive roof waterproofing product contains at least 2 times, preferably at least 2.5 times, in particular at least 3 times as much weight percent solids content of polymers as weight percent mineral binder. The weight percent refers here to the weight of the entire reactive liquid applied roof waterproofing product.

In addition, it is provided that the proportion of PU polymer in the liquid component is a maximum of 30%, preferably less than 20%, further preferably less than 15% of the solids content of polymers, namely based on the total mass of the polymers.

Furthermore, it is provided that at least one of the polymers used in the reactive roof waterproofing product has a glass transition temperature T_{g} of less than −20° C., preferably less than −30° C. Preferably, at least 50% by weight, more preferably at least 80% by weight, still more preferably at least 90% by weight, and in particular 100% by weight of the polymers used, based on the total mass of the polymers, have a glass transition temperature T_{g} of less than −20° C., preferably less than −30° C.

The reactive liquid applied roof waterproofing product is suitable as a roofing membrane for the sealing of roof surfaces, but also for covering, in particular and not conclusively, of detail and connecting areas, balconies, terraces and access galleries.

Surprisingly, it has been found that excellent properties for roof waterproofing can be reliably realised with these quantity ratios and properties of the binder (systems). The result is a waterproof, flexible, fast-curing, ageing-resistant and UV-stable roofing membrane.

Advantageously, the addition of the mineral binder system, which is capable of forming an ettringite phase, allows a significant acceleration of the curing of the reactive roof waterproofing product, in principle independent of weather conditions. This is achieved by the rapid binding of water contained in the polymer dispersion in the ettringite phase.

With a polymer content of less than 2 times the weight percent of polymers as the weight percent of mineral binder, based on the total weight of the reactive roof waterproofing product, the mineral binder system predominantly determines the curing reaction with the effect that an overly rigid, three-dimensional cement matrix with polymer particles is formed and the required flexibility and crack bridging properties of a roofing membrane cannot be achieved.

Preferably, the reactive liquid applied roof waterproofing product contains not more than 10 times, preferably not more than 5 times as much weight percent solids content of polymers as weight percent mineral binders. If the polymer content is even higher, the polymer would determine the drying process with the effect that a polymer matrix with cement islands is created without a coherent cement structure therein, cf. also FIG. 3. In general, it was observed that with a higher polymer content, curing is no longer significantly accelerated due to the mineral binder system and the formation of an ettringite phase and thus, similar to exclusively physically drying one-component polymer waterproofing systems, there is a high dependence of curing on weather conditions. Too slow or weather-dependent curing or drying of the product, as well as a late development of rain resistance due to weather conditions, lead to the product being unsuitable as a roofing membrane according to the invention.

It has been shown that a proportion of preferably at least 5% PU polymer in the solids content of polymers has a positive effect on elasticity at particularly low temperatures of −30° C. and below comparable to the incorporation of a reinforcement, e.g. a reinforcement with polyester non-woven fabric (110 g/m₂₎. In addition, it has been shown that when more than 30% of the PU polymer is introduced to the solids content of polymers, negative effects occur, e.g. coagulation of polymer particles, which impair the formation of a continuous sealing layer. In tests, long drying times and partial to complete inhibition of the cement reaction were observed. Above 20% and 15%, a qualitatively poorer behaviour during curing can be observed. In addition, it has been shown that the introduction of at least 1% PU polymer, based on the solids content of polymers, has a significant influence on the inner tension of the polymer film.

In contrast to a polyurethane-based thickener, which can be used to control the rheological properties of the liquid component and thus of the reactive liquid applied roof waterproofing product, the use of a PU polymer dispersion used in the invention does not result in any relevant increase or change in the rheological properties, in particular the viscosity, of the liquid component produced and thus of the reactive liquid applied roof waterproofing product. The PU polymer described here as a PU polymer dispersion forms the described polymer film with one or more other polymers used.

Preferably, the reactive liquid applied roof waterproofing product is available as a two-component (2K) system. The mineral binders are in particular preferably present in a powder component. The one or more aqueous polymer dispersions are in particular preferably present in a liquid component. The two components can be stored separately or in any container, but separately therein, in particular, for example, in buckets or foil bags or the like. The two-component reactive roof waterproofing product is characterized by its particularly easy processability, without the use of burners, additional adhesives or welding agents and enables application in a few work steps.

Furthermore, the two-component reactive roof waterproofing product is also characterized by rapid through-drying, which is based on a chemical reaction between constituents of the liquid component and constituents of the powder component and, among other things, on the formation of an ettringite phase, which in particular reduces the risk of mechanical damage to the coating during drying.

An advantage of using polymer dispersions is that the organic polymer particles are stabilised in an aqueous medium with the help of emulsifiers.

A polymer dispersion is a colloidal stable dispersion of polymer particles in an aqueous phase. The solids content (weight percent) of the polymer dispersion describes the mass of the polymer dispersed in the aqueous phase.

In contrast to polymer dispersions, polymer powders are the (mostly spray-) dried form of these aqueous polymer dispersions. In order to produce a stable powder, drying aids are usually used, e.g. protective colloids, and anti-blocking agents, e.g. precipitated or pyrogenic silica, kaolin (aluminium silicate), bentonite, talc, clays, light spar, calcium carbonate, magnesium carbonate, barium sulphate, etc. Anti-blocking agents improve the ability of the powder to flow and prevent clogging of the powder during storage. Protective colloids are used as drying aids, which prevent the polymer particles from sticking together and control the particle sizes of the powder. The advantage of polymer powders is that the polymer is pre-mixed with other powders such as mineral binders or mineral aggregates or similar in order to redisperse it with water only immediately before use, resulting in lower transport and storage costs. In addition, polymer powders do not need to be preserved. A major disadvantage of polymer powders, however, is the reduced water resistance of the end products in contrast with aqueous polymer dispersion, for example due to the necessary addition of protective colloids such as polyvinyl alcohol. Furthermore, the content of pure polymer is reduced by the additives required for drying. Therefore, the performance of the initial dispersion is not achieved again in the redispersed state in the case of polymer powders.

The polymer dispersions preferably have a minimum film forming temperature (MFT) of 0° C. If the MFT is below room temperature, the dispersion can form a closed, flexible film by drying. This polymer film provides the desired flexibility and crack bridging ability in mineral two-component systems. According to DIN 53787:02-74, the MFT is the lowest temperature at which a thin layer of a plastic dispersion still dries to a coherent film. The MFT of the polymer dispersions is determined as described in the aforementioned standard.

Particularly preferably, the following proportions of polymer are contained in the liquid component:

| | wt.-% | preferable wt.-% |
|---|---|---|
| Polymer | 30-70 | 50-60 |

Here, the specification refers to the solids content of the polymer in the polymer dispersion. The solids content of polymers in the polymer dispersion is therefore preferably between 30% and 70%, particularly preferably between 50% and 60%, based on the weight of the liquid component.

Advantageously, the polymer composition in the liquid component contains up to 30% by weight of a PU polymer. Particularly preferably, PU polymer contents of 5-10 wt.-% are contained in the polymer composition of the liquid component. Here, the indication of weight percent refers to the proportion of PU polymer in the total polymer mass.

Particularly preferably, the following proportions of water are contained in the liquid component:

| | wt.-% | preferable wt.-% |
|---|---|---|
| Water | 30-80 | 40-50 |

Here, the indication of weight percent refers to the proportion of water in the liquid component. This includes any water contained in the liquid component.

Particularly preferably, the following proportions are contained in the powder component as a mineral binder system:

| | wt.-% | preferable wt.-% |
|---|---|---|
| Mineral binder system | 10-30 | 15-20 |

Here, the indication of weight percent refers to the proportion of the mass of the mineral binders, which in combination form the mineral binder system, compared to the mass of the powder component.

Particularly preferably, the following filler proportions are contained in the powder component:

| | wt.-% | preferable wt.-% |
|---|---|---|
| Fillers | 70-90 | 80-85 |

Here, the indication of weight percent refers to the proportion of the mass of fillers present in the powder component compared to the mass of the powder component.

For example, the powder component may contain the following composition:

| | wt.-% | preferable wt.-% |
|---|---|---|
| Aluminate cement | 5-25 | 10-15 |
| Portland cement | 2-12 | 3-6 |
| Calcium sulphate carrier | 2-8 | 3-6 |
| TiO2 | 0-4 | 0-2 |
| Filler | 55-80 | 58-70 |

Suitable mineral binder systems consist in particular of a mixture of cements and calcium sulphate carriers, which are characterized as a mixture in particular by the ability to form an ettringite phase. Particularly suitable mineral binders are Portland cement, calcium aluminate cement, hereinafter referred to as aluminate cement, as well as calcium sulphoaluminate cement, lime and gypsum.

Suitable polymers have a glass transition temperature T_{g} of preferably less than −20° C. and further preferably less than −30° C., measured by means of a DSC method. If polymers with too high a T g are used, the required flexibility cannot be achieved at low temperatures (−20° C. and lower), as the polymer film behaves like glass below the T_{g} of the polymers contained and thus breaks when stressed. The glass transition temperature T_{g} of the polymer sample is determined by differential scanning calorimetry (DSC, DIN EN ISO 11357-2:2014-07 “Plastics—Differential scanning calorimetry (DSC)—Part 2: Determination of glass transition temperature and glass transition step height (ISO 11357-2:2013), German version EN ISO 11357-2:2014”). The sample is heated in steps of 10° C. per minute from −90° C. to 20° C. and the heat capacity is determined. A transition point of the heat capacity below and above the glass transition is determined.

A polymer is a chemical compound consisting of chain or branched molecules (macromolecules) consisting of the same or similar units, the so-called monomers. A polymer can be a natural or synthetic macromolecule consisting of repeating units of a smaller molecule, monomers.

Preferably, at least one of the polymers is based on one or more monomers of the group comprising (meth)acrylates, acrylonitrile, isocyanate, polyols, or a combination thereof, for example pure acrylate, polyurethane or styrene acrylate. Surprisingly, it has been found that polymers based on these monomers can be used to achieve the roof waterproofing properties described above.

Examples of (meth-)acrylates are methacrylic acid esters and acrylic acid esters of branched and unbranched alcohols with 1 to 15 carbon atoms. Suitable methacrylic acid esters include methyl methacrylate, ethyl methacrylate, n-propyl methacrylate, i-propyl methacrylate, n-butyl methacrylate, i-butyl methacrylate, t-butyl methacrylate and neopentyl methacrylate. Suitable acrylic acid esters include methyl acrylate, ethyl acrylate, n-propyl acrylate, i-propyl acrylate, n-butyl acrylate, i-butyl acrylate, t-butyl acrylate and 2-ethylhexyl acrylate.

Alternatively, or in addition, it may be provided that at least one of the polymers is a conditioned natural latex. Natural latex rubber is a polymer of the monomer isoprene (2-methyl-1,3-butadiene) and has a uniform structure with cis-1,4 linkage. Therefore, at least one of the polymers can contain the conditioned natural latex as the sole polymer. Alternatively, at least one of the polymers may contain the conditioned natural latex, which is further crosslinked or polymerized as a pre-polymer with other monomers and/or substances. The conditioning of the natural latex can be carried out, for example, by ammonia or potassium hydroxide. Preferably, a partially pre-vulcanized conditioned natural substance is used. The above-described properties for roof sealing can also be reliably realized by means of conditioned natural latex.

In the case of conditioned natural latex, reactive liquid applied building material preferably contains at least 2 times, further preferably at least 2.5 times as much weight percent of conditioned natural latex as weight percent of mineral binder. Surprisingly, it has been found that the roof waterproofing properties described above can be reliably realised with these quantity ratios.

If the reactive liquid applied building material contains at least 2 times as much weight percent of conditioned natural latex as weight percent of mineral binder, then it is sufficiently flexible and crack-bridging down to −20° C. If the reactive liquid applied building material contains at least 2.5 times as much weight percent of conditioned natural latex as weight percent of mineral binder, then it is sufficiently flexible and crack-bridging down to −30° C.

Preferably, the reactive liquid applied building material contains at most 10 times, and more preferably at most 5 times, as much weight percent of conditioned natural latex as weight percent of mineral binder.

Preferably, the at least one polymer is a homopolymer such as polystyrene, poly(meth)acrylate or (meth)acrylate polymer of a monomer unit, polybutadiene or polyacrylonitrile. Alternatively, it is preferred that the at least one polymer is a copolymer such as acrylonitrile-butadiene copolymer, acrylonitrile copolymer, butadiene copolymer, acrylonitrile-acrylate copolymer, acrylonitrile-methacrylate copolymer, acrylonitrile butadiene acrylate copolymer, acrylate butadiene copolymer, acrylonitrile butadiene methacrylate copolymer, methacrylate butadiene copolymer, acrylonitrile butadiene styrene copolymer, styrene acrylonitrile copolymer, styrene-butadiene copolymer, acrylonitrile-styrene acrylate copolymer, acrylate-styrene copolymer, acrylonitrile-styrene methacrylate copolymer, methacrylate-styrene copolymer, acrylonitrile-styrene-butadiene acrylate copolymer, acrylate-styrene-butadiene copolymer, acrylonitrile-styrene-butadiene-methacrylate copolymer, methacrylate-styrene-butadiene copolymer, alternatively particularly preferably acrylate copolymer, methacrylate copolymer or polyurethane. Furthermore, the copolymer may be a (meth)acrylate copolymer containing more than one monomer unit.

In one embodiment, the aqueous polymer dispersion contains two or more polymers. Preferred here are acrylate polymer and polyurethane or acrylate polymer and conditioned natural latex.

In one embodiment, the aqueous polymer dispersion contains at least one copolymer. This is preferably an acrylate copolymer.

In one embodiment, the reactive liquid applied building material contains a calcitic filler and the aqueous polymer dispersion contains a conditioned natural latex. The chemical interaction between the conditioned natural latex and the Ca2+ ions proves to be advantageous here.

In an advantageous embodiment, the reactive liquid applied building material contains one or more UV-stabilising and IR-reflecting pigments.

Further pigments, in particular colour pigments, can be included to enable individual design of the roof surface by pigmentation of the roofing membrane.

Furthermore, the reactive liquid applied roof waterproofing product preferably contains one or more fillers, in particular mixtures of one or more siliceous and/or calcitic fillers, as well as one or more light fillers on a siliceous basis. In the context of the present disclosure, light fillers are fillers that have a bulk density of less than 500 g/I. Examples of lightweight fillers include hollow glass microspheres, or silicon oxide. Examples of silicate fillers are quartz sand and powdered quartz, while examples of calcitic fillers are limestone powder, calcium carbonate, dolomite and chalk, preferably limestone powder.

Alternatively or in addition, the fillers may contain recycled materials. Examples of recycled materials are rubber granules or plastic granules. For example, rubber granules are used that are produced from waste rubber such as material from rubber seals, rubber hoses, rubber linings, hard rubber, soft rubber, used tyres, rubber grips or the like. The rubber granulate is preferably based on vulcanized natural rubber and/or vulcanized synthetic rubber, preferably on unsaturated rubber with styrene and butadiene units.

Furthermore, the reactive liquid applied building material preferably contains one or more additives, in particular additives from the group comprising thickeners such as polyurethane thickeners, acrylate thickeners, defoamers, wetting agents, accelerators, retarders, dispersants, cross-linking agents, preservatives and fire retardants.

Examples of thickeners include polysaccharides such as cellulose ethers, modified cellulose, modified cellulose ethers, starch ethers, guar gum, xanthan gum, polycarboxylic acids such as polyacrylic acid and its partial esters, polyvinyl alcohols, hydrophobically modified polyvinyl alcohols, acetalised polyvinyl alcohols, bentonite, casein, associative thickeners, polyurethane thickeners and acrylate thickeners. Other examples of thickeners are phyllosilicates. Examples of phyllosilicates are mica, talc, serpentine and clay minerals such as vermiculite, in particular muscovite, bentonite and kaolinite.

Defoamers can be silicone-based, for example silicone oil-based, but also vegetable oil-based and mineral oil-based.

Wetting agents or dispersants may be anionic, cationic and/or non-ionic detergents.

Examples of accelerators are alkali or alkaline earth salts of inorganic acids such as alkaline carbonates such as sodium carbonate, lithium carbonate or aluminates such as tricalcium aluminate.

Retarders can be a combination of several inorganic and/or organic substances such as phosphates, lignosulphonates, sugar (derivatives) such as sucrose, sucrose, glucose, fructose, saccharides, sorbitol, pentaerythritol, hydroxycarbon acids such as citric acid, tartaric acid, gluconic acid or dicarboxylic acids such as oxalic acid, succinic acid or their salts.

Examples of cross-linking agents are metal oxides and metal salts, semi-metal oxides, boric acid or its salts, or dialdehydes such as glutardialdehyde, but also metals such as zirconium.

Examples of fire retardants are expandable graphites or aluminium hydroxide.

Other fillers that can be used are fibres, both organic and inorganic, such as basalt, glass fibres, polypropylene fibres, carbon fibres and polyester fibres.

For example, the liquid component may contain the following additives:

| | wt.-% | preferable wt.-% |
|---|---|---|
| Thickener | 0-1 | 0.14-0.4 |
| Defoamer | 0-1 | 0.2-0.7 |

According to a further aspect of the invention, a roofing membrane is prepared by mixing a liquid component and a powder component, the powder component comprising a mineral binder system capable of forming ettringite and thus capable of rapidly binding water, consisting of one or more mineral binders, and the liquid component comprising one or more aqueous polymer dispersions, of which an aqueous polyurethane polymer dispersion may hereinafter always be referred to as a PU dispersion.

It is provided that the roofing membrane contains at least 2 times, preferably at least 2.5 times, in particular at least 3 times as much weight percent solids content of polymers as weight percent mineral binder, based on the total weight of the roofing membrane, and the proportion of PU dispersion is at most 30% of the solids content of polymers. At least one of the polymers used in the reactive roof waterproofing product has a glass transition temperature T_{g} of less than −20° C., preferably less than −30° C.

Advantageously, the roofing membrane in a cured state at temperatures up to at least TL3, preferably TL4, according to ETAG 005, Part 1, in the revision of March 2004, is flexible with a classification W3 after performing a process specified in EOTA TR-008 and crack bridging for cracks up to at least 1.5 mm after performing a process specified in EOTA TR-013.

The roofing membrane is thus advantageously designed to be flexible and crack-bridging down to at least −20° C., preferably down to −30° C. The temperatures, the performance classes as well as the references to the EOTA Technical Reports are defined in ETAG 005, Part 1.

If the roofing membrane contains at least 2 times as much weight percent of polymers as weight percent of mineral binders, based on the total weight of the reactive roof waterproofing product, then it is sufficiently flexible and crack-bridging down to −20° C. in the cured state. If the roofing membrane contains at least 2.5 times as much weight percent of polymers as weight percent of mineral binders, based on the total weight of the reactive roof waterproofing product, then it is sufficiently flexible down to −25° C. and sufficiently crack-bridging down to −20° C. If the roofing membrane contains at least 3 times as much weight percent of polymers as weight percent of mineral binders, based on the total weight of the reactive roof waterproofing product, then it is sufficiently flexible and crack-bridging down to −30° C.

In terms of its crack-bridging properties, the roofing membrane is superior to all comparable roofing membranes known to date and is characterized by outstanding adhesion to various substrates, such as mineral, metallic, wooden and plastic-based substrates and provides a permanently resistant roofing membrane or sealing of substrates even at low temperatures in winter.

Advantageously, the roofing membrane in a cured state, preferably at temperatures up to at least TL3, preferably TL4, according to ETAG 005, Part 1, in the revision of March 2004, is designed to be shock-resistant with a classification P4 after performing a process specified in EOTA TR-006 (dynamic indentation).

The roofing membrane is thus advantageously designed to be shock-resistant down to at least −20° C., preferably down to −30° C., and is thus excellently suited as a permanently resistant roofing membrane or sealing of substrates even at low temperatures in winter.

In particular, the roofing membrane in a cured state preferably at temperatures up to at least TH4 according to ETAG 005, Part 1, in the revision of March 2004, is designed to be shock-resistant with a classification P4 after performing a process specified in EOTA TR-007 (static indentation). The reactive liquid applied roof waterproofing product is thus preferably also designed to be structurally resistant to penetration up to at least 90° C. Advantageously, the roofing membrane thus provides a permanently resistant waterproofing or sealing of substrates even at high temperatures in summer and under direct sunlight.

In particular, the roofing membrane in a cured state preferably at temperatures up to at least TL3, preferably TL4, according to ETAG 005, Part 1, is flexible according to a test based on the test of the cold bending behaviour according to DIN 52123:2014-06, where during the test based on the cold bending behaviour according to DIN 52123: 2014-06, samples of the roofing membrane with layer thicknesses between 1.9 mm and 2.3 mm are bent over a cylinder with a diameter of 4 cm in the cured state after 24 hours of storage and visually inspected for the formation of cracks >0.1 mm.

More preferably, the roofing membrane is designed to be UV resistant in the cured state at temperatures down to at least −10° C. according to ETAG 005, Part 1 and Part 8, revision March 2004, according to category “M” or “S” with a classification W3 after performing a process specified in EOTA TR-010.

In particular, the roofing membrane in a cured state is designed such that it has a tensile stress of greater than 0.5 N/mm², preferably greater than 1 N/mm², particularly preferably greater than 1.5 N/mm², and a tensile elongation at maximum stress of greater than 20%, preferably greater than 30%, particularly preferably greater than 40%, when tested for tensile properties in accordance with DIN EN ISO 527-1:2019-12 “Plastics—Determination of tensile properties”. An increase in the measured tensile stress to more than 1.5 N/mm² can be achieved by using more than 1 wt.-% PU polymer, based on the total mass of the polymers.

According to yet another aspect of the invention, a roofing membrane is prepared by mixing a liquid component and a powder component, the powder component comprising a mineral binder system capable of forming ettringite and thus capable of rapidly binding water, consisting of one or more mineral binders, and the liquid component comprising one or more aqueous polymer dispersions, of which an aqueous polyurethane polymer dispersion may hereinafter always be referred to as a PU dispersion. It is provided that the roofing membrane in a cured state at temperatures up to at least TL3, preferably TL4, according to ETAG 005, Part 1, in the revision of March 2004, is flexible with a classification W3 after performing a process specified in EOTA TR-008 and crack bridging for cracks up to at least 1.5 mm after performing a process specified in EOTA TR-013. The roofing membrane is thus advantageously designed to be flexible and crack-bridging down to at least −20° C., preferably down to −30° C. The temperatures, the performance classes as well as the references to the EOTA Technical Reports are defined in ETAG 005, Part 1. In particular, the roofing membrane may have the compositions and properties described above.

According to yet another aspect of the invention, a method of manufacturing a roofing membrane comprises the following steps:
Mixing the above-described reactive liquid applied building material, and
Applying the building material to a surface of the structure, such as a flat roof, a balcony, a detail and connection area, a terrace or an access gallery.

Accordingly, the invention also relates to a roofing membrane as a result of the above-mentioned process, both after application in the still liquid state and in the cured state.

The characteristics described above in relation to the substances and devices are also to be regarded as disclosed in relation to the methods, without the need for explicit repetition.

In preferred embodiments, the roofing membrane is applied to the surface of the roof with a layer thickness of 1 to 5 mm, preferably 2 to 3 mm.

In one embodiment, the reactive liquid applied roof waterproofing product is applied with a reinforcing non-woven, a fabric, a fabric mat or with at least one reinforcing material, in particular fibres. The non-woven has as material fibres such as glass fibres and/or basalt fibres and/or organic fibres such as polypropylene fibres, polyethylene fibres or polyester fibres. For example, the non-woven is formed as a polyester fibre non-woven or stainless steel fibre non-woven, preferably as a polyester fibre non-woven. The reinforcing material preferably comprises glass fibres and/or plastic fibres such as polyvinyl alcohol fibres, polyester fibres, polypropylene fibres, polyamide fibres, polyethylene fibres and/or aramid fibres.

### FIGURES

FIGS. 1-3 show schematic representations to explain the reaction mechanism of the reactive roofing membrane. FIGS. 1-3 schematically show reaction products that are formed when mixing two-component reactive roof waterproofing products with different compositions of polymers and mineral binders.

FIG. 1 shows the result of an optimal reaction according to the invention. The cement reaction, shown in the form of star-shaped structures, for example ettringite needles, is interspersed with the polymer film, shown in the form of irregular lines. In this reaction, the film formation of the polymer occurred simultaneously with the formation of the mineral binder matrix. The result is a waterproof, flexible, fast-curing, ageing-resistant and UV-stable roofing membrane.

FIG. 2 shows a result of a reaction not according to the invention. Here the mineral binder system determined the reaction. First, in this example, the formation of the cement hydrate phases took place without the incorporation of the polymer matrix. Late formation of the polymer film leads to the formation of a rigid three-dimensional cementitious binder matrix with globally filmed polymer particles in it, from which no flexible reactive roofing membrane can be formed.

FIG. 3 shows another result of a reaction not according to the invention. Here the polymer content determined the reaction. In this process, primarily physical drying took place. Early filming of the polymer results in a polymer matrix with few ettringite needles or cement islands therein. The result is a flexible product with low tensile stress, low water resistance and slow curing, which, depending on the degree of formation of the cementitious binder matrix, is unsuitable as a roofing membrane, e.g. due to excessive water absorption of the waterproofing film.

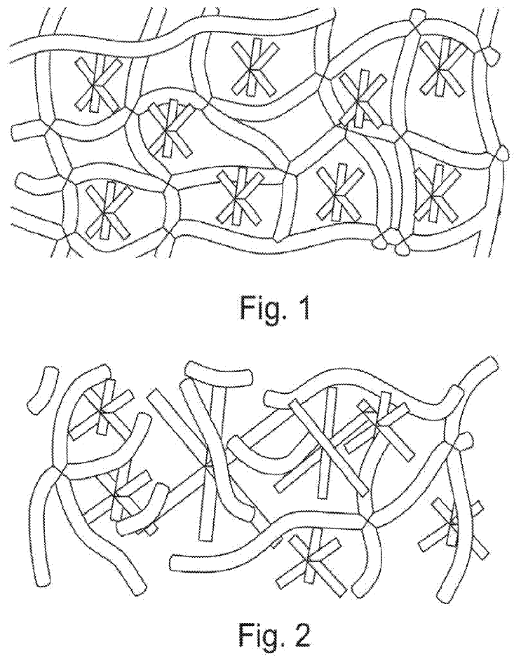

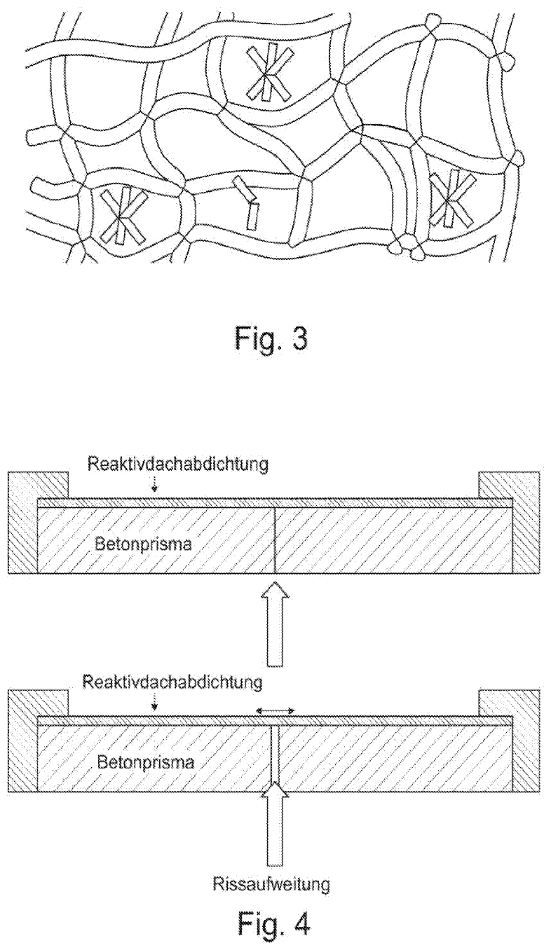

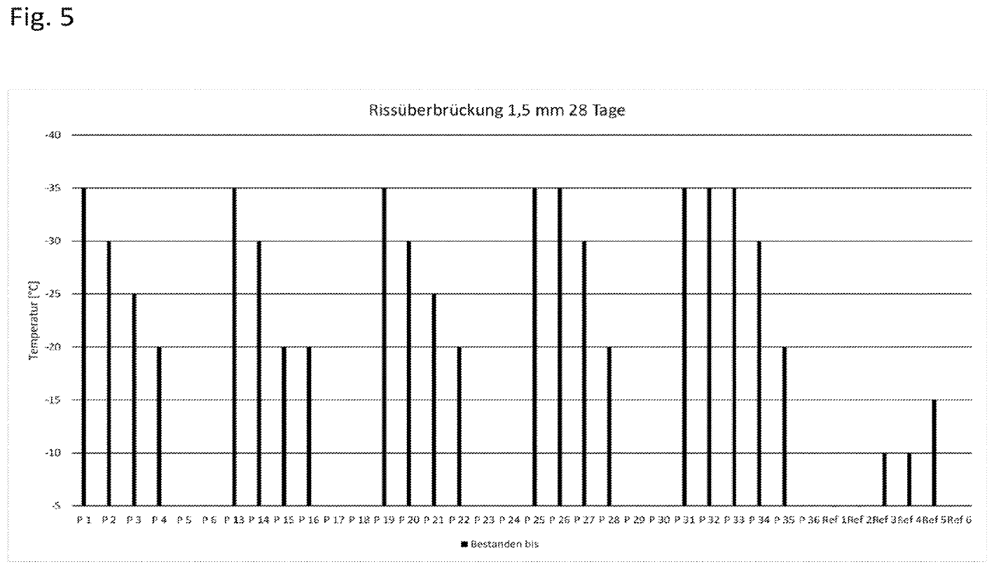

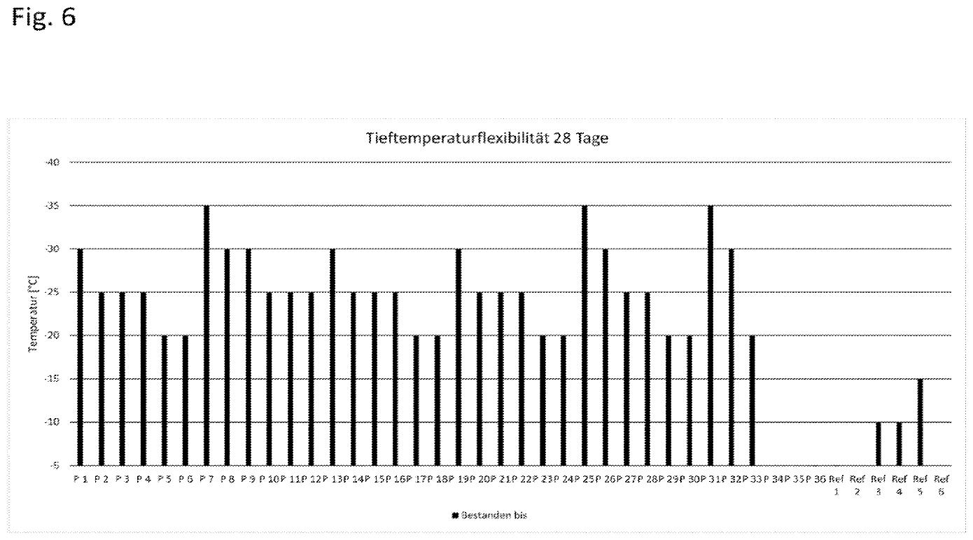

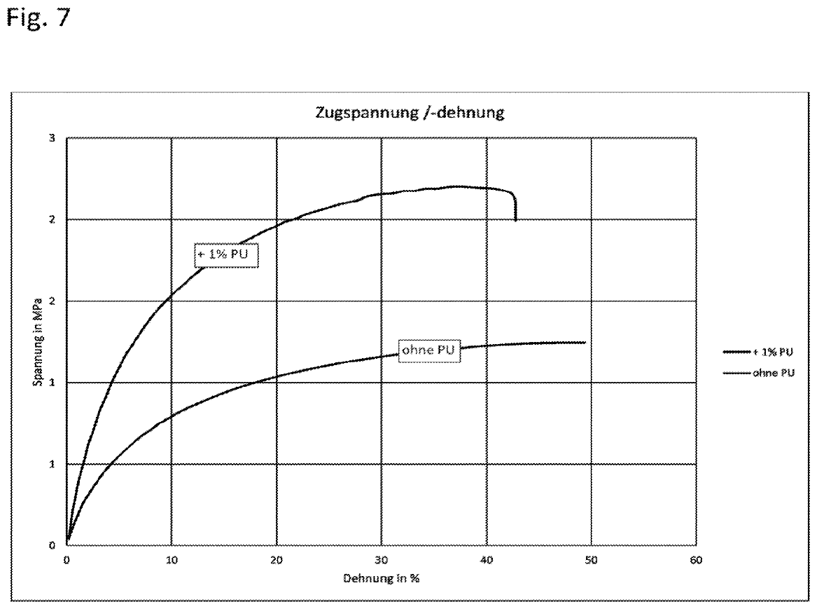

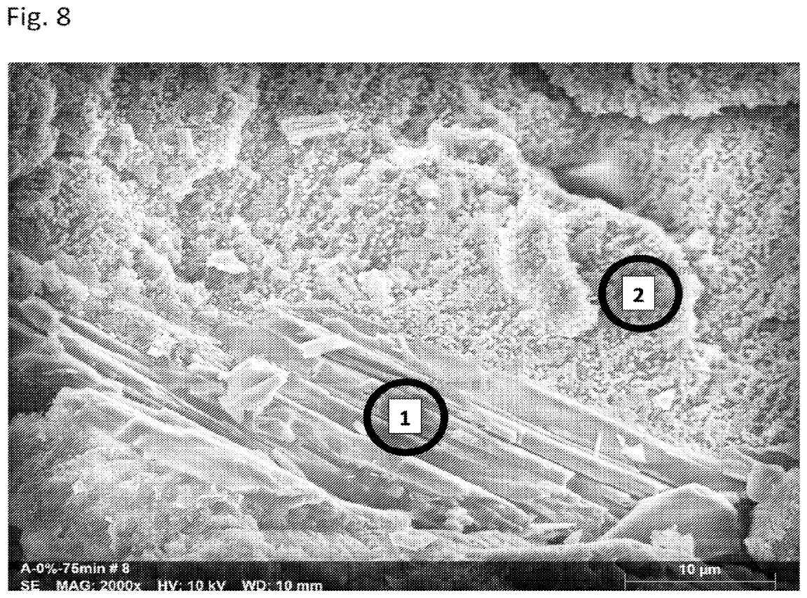

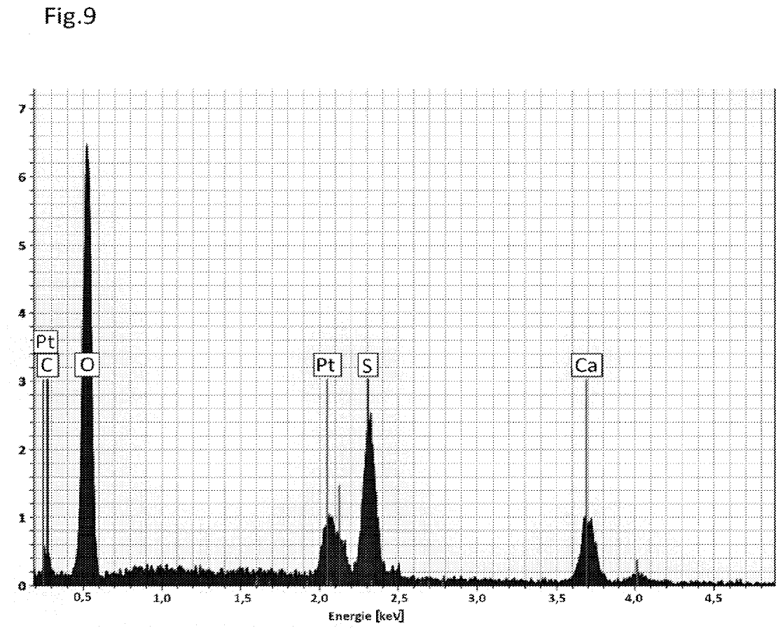

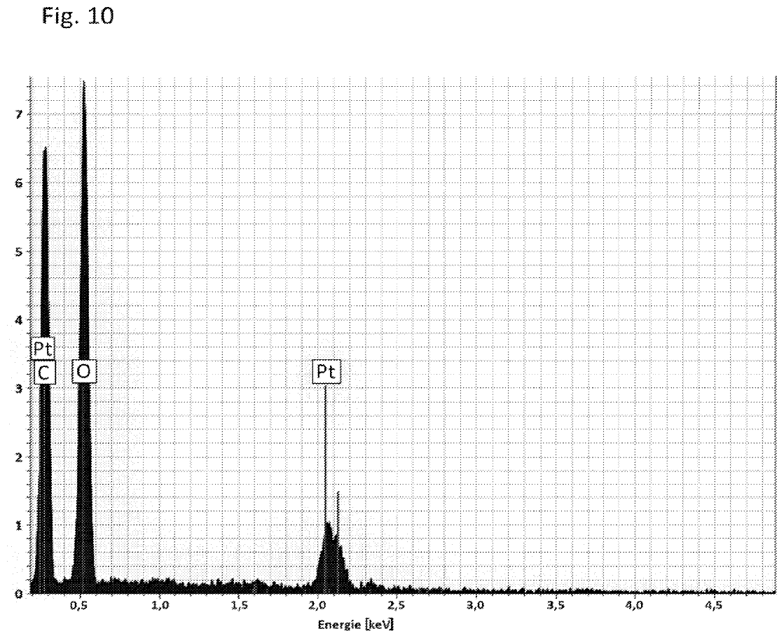

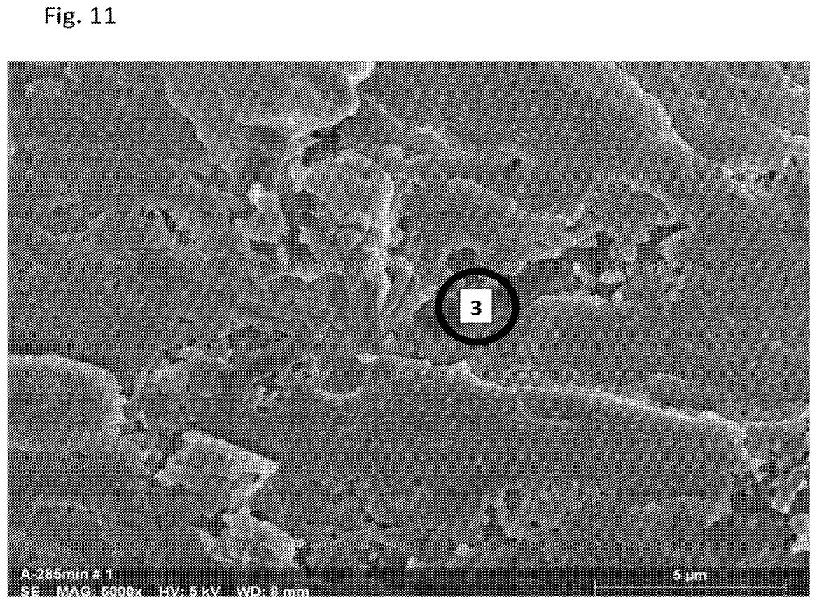

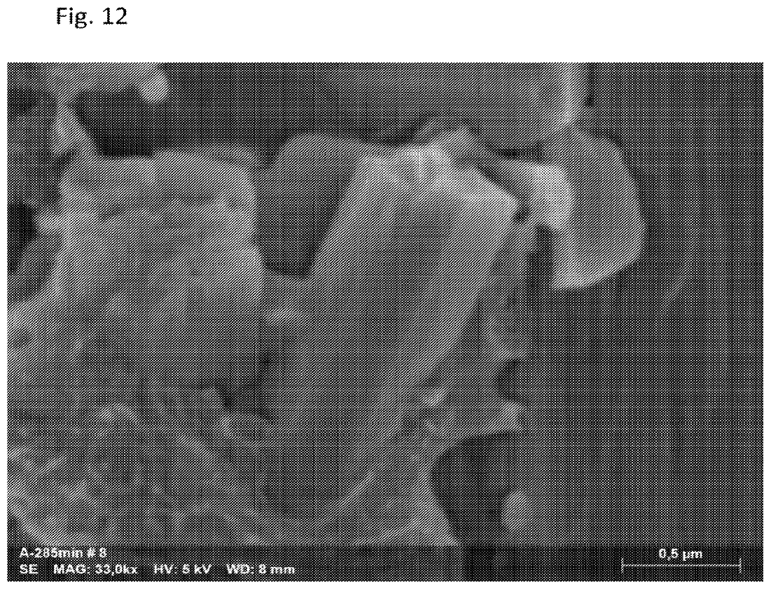

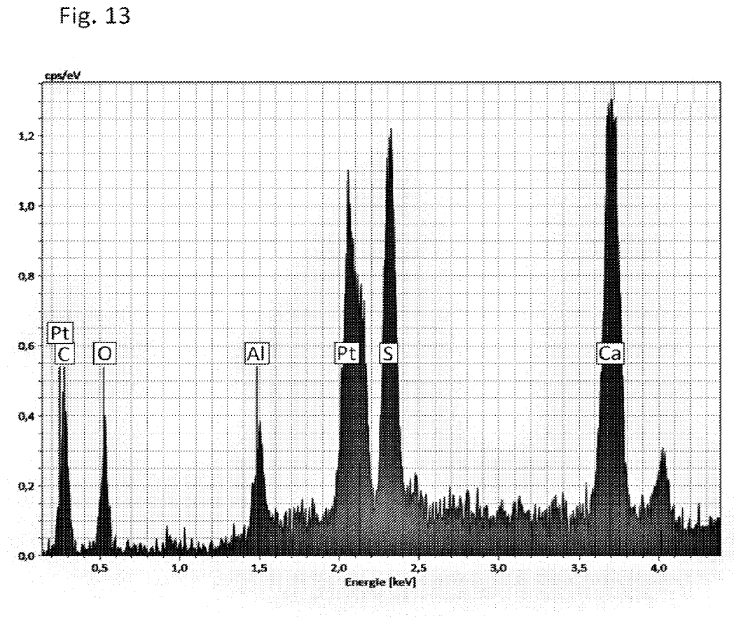

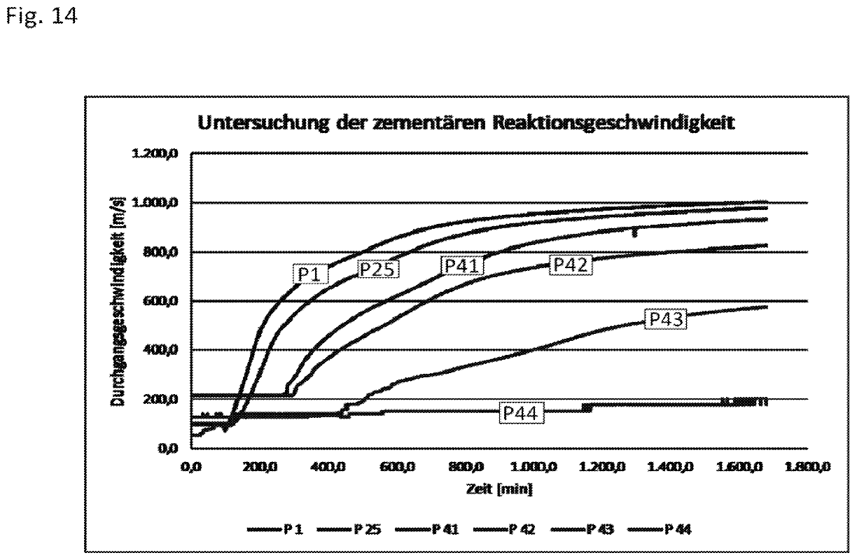

### EXAMPLES

| | | P1 | P2 | P3 | P4 | P5 | P6 |
|---|---|---|---|---|---|---|---|
| powder comp. [%] | | | | | | | |
| aluminate cement | mineral binder | 11.38 | 13.62 | 17.04 | 22.8 | 27.36 | 34.2 |
| Portland cement | system | 2.84 | 3.41 | 4.26 | 5.7 | 6.84 | 8.55 |
| calcium sulphate | | 3.79 | 4.54 | 5.68 | 7.6 | 9.12 | 11.4 |
| hemihydrate | | | | | | | |
| filler | fillers | 64.99 | 61.43 | 56.02 | 46.9 | 39.68 | 28.85 |
| light filler | | 16 | 16 | 16 | 16 | 16 | 16 |
| additives | additives | 1 | 1 | 1 | 1 | 1 | 1 |
| Total | | 100.00 | 100.00 | 100.00 | 100.00 | 100.00 | 100.00 |
| liquid comp. [%] | | | | | | | |
| acrylate polymer | polymer | 54 | 54 | 54 | 54 | 54 | 54 |
| PU polymer | dispersion(s) | 0 | 0 | 0 | 0 | 0 | 0 |
| water | | 45.5 | 45.5 | 45.5 | 45.5 | 45.5 | 45.5 |
| defoamer | additives | 0.2 | 0.2 | 0.2 | 0.2 | 0.2 | 0.2 |
| thickener | | 0.3 | 0.3 | 0.3 | 0.3 | 0.3 | 0.3 |
| Total | | 100.00 | 100.00 | 100.00 | 100.00 | 100.00 | 100.00 |
| mixing ratio PC:LC | | 1 | 1 | 1 | 1 | 1 | 1 |
| polymers [wt.-%] | in each case based | 27 | 27 | 27 | 27 | 27 | 27 |
| mineral binder | on the total mass of | 9.01 | 10.79 | 13.49 | 18.05 | 21.66 | 27.08 |
| [wt.-%] | the reactive liquid | | | | | | |
| ratio of wt.-% polymers | applied roof | 3.00 | 2.50 | 2.00 | 1.50 | 1.25 | 1.00 |
| to wt.-% mineral | waterproofing | | | | | | |
| binder | product | | | | | | |
| reinforcement | | No | No | No | No | No | No |
| non-woven | | | | | | | |
| proportion of PU | | 0.0% | 0.0% | 0.0% | 0.0% | 0.0% | 0.0% |
| polymer in total mass of | | | | | | | |
| polymers | | | | | | | |
| highest measured Tg | | −35 | −35 | −35 | −35 | −35 | −35 |
| according to DSC of | | | | | | | |
| the polymers used | | | | | | | |
| [° C.] | | | | | | | |
| Low temperature | | −30 | −25 | −25 | −25 | −20 | −20 |
| elasticity minimum | | | | | | | |
| temp. [° C.] | | | | | | | |
| Crack bridging | | −35 | −30 | −25 | −20 | −5 | −5 |
| (1.5 mm) minimum | | | | | | | |
| temp. [° C.] | | | | | | | |
| | | P7 | P8 | P9 | P10 | P11 | P12 |
| powder comp. [%] | | | | | | | |
| aluminate cement | mineral binder | 11.38 | 13.62 | 17.04 | 22.8 | 27.36 | 34.2 |
| Portland cement | system | 2.84 | 3.41 | 4.26 | 5.7 | 6.84 | 8.55 |
| calcium sulphate | | 3.79 | 4.54 | 5.68 | 7.6 | 9.12 | 11.4 |
| hemihydrate | | | | | | | |
| filler | fillers | 64.99 | 61.43 | 56.02 | 46.9 | 39.68 | 28.85 |
| light filler | | 16 | 16 | 16 | 16 | 16 | 16 |
| additives | additives | 1 | 1 | 1 | 1 | 1 | 1 |
| Total | | 100.00 | 100.00 | 100.00 | 100.00 | 100.00 | 100.00 |
| liquid comp. [%] | | | | | | | |
| acrylate polymer | polymer | 54 | 54 | 54 | 54 | 54 | 54 |
| PU polymer | dispersion(s) | 0 | 0 | 0 | 0 | 0 | 0 |
| water | | 45.5 | 45.5 | 45.5 | 45.5 | 45.5 | 45.5 |
| defoamer | additives | 0.2 | 0.2 | 0.2 | 0.2 | 0.2 | 0.2 |
| thickener | | 0.3 | 0.3 | 0.3 | 0.3 | 0.3 | 0.3 |
| Total | | 100.00 | 100.00 | 100.00 | 100.00 | 100.00 | 100.00 |
| mixing ratio PC:LC | | 1 | 1 | 1 | 1 | 1 | 1 |
| polymers [wt.-%] | in each case based | 27 | 27 | 27 | 27 | 27 | 27 |
| mineral binder | on the total mass of | 9.01 | 10.79 | 13.49 | 18.05 | 21.66 | 27.08 |
| [wt.-%] | the reactive liquid | | | | | | |
| ratio of wt.-% polymers | applied roof | 3.00 | 2.50 | 2.00 | 1.50 | 1.25 | 1.00 |
| to wt.-% mineral | waterproofing | | | | | | |
| binder | product | | | | | | |
| reinforcement | | Yes | Yes | Yes | Yes | Yes | Yes |
| non-woven | | | | | | | |
| proportion of PU | | 0.0% | 0.0% | 0.0% | 0.0% | 0.0% | 0.0% |
| polymer in total mass of | | | | | | | |
| polymers | | | | | | | |
| highest measured Tg | | −35 | −35 | −35 | −35 | −35 | −35 |
| according to DSC of | | | | | | | |
| the polymers used | | | | | | | |
| [° C.] | | | | | | | |
| Low temperature | | −35 | −30 | −30 | −25 | −25 | −25 |
| elasticity minimum | | | | | | | |
| temp. [° C.] | | | | | | | |
| Crack bridging | | n.a. | n.a. | n.a. | n.a. | n.a. | n.a. |
| (1.5 mm) minimum | | | | | | | |
| temp. [° C.] | | | | | | | |
| | | P13 | P14 | P15 | P16 | P17 | P18 |
| powder comp. [%] | | | | | | | |
| aluminate cement | mineral binder | 11.38 | 13.62 | 17.04 | 22.8 | 27.36 | 34.2 |
| Portland cement | system | 2.84 | 3.41 | 4.26 | 5.7 | 6.84 | 8.55 |
| calcium sulphate | | 3.79 | 4.54 | 5.68 | 7.6 | 9.12 | 11.4 |
| hemihydrate | | | | | | | |
| filler | fillers | 64.99 | 61.43 | 56.02 | 46.9 | 39.68 | 28.85 |
| light filler | | 16 | 16 | 16 | 16 | 16 | 16 |
| additives | additives | 1 | 1 | 1 | 1 | 1 | 1 |
| Total | | 100.00 | 100.00 | 100.00 | 100.00 | 100.00 | 100.00 |
| liquid comp. [%] | | | | | | | |
| acrylate polymer | polymer | 53.46 | 53.46 | 53.46 | 53.46 | 53.46 | 53.46 |
| PU polymer | dispersion(s) | 0.54 | 0.54 | 0.54 | 0.54 | 0.54 | 0.54 |
| water | | 45.5 | 45.5 | 45.5 | 45.5 | 45.5 | 45.5 |
| defoamer | additives | 0.2 | 0.2 | 0.2 | 0.2 | 0.2 | 0.2 |
| thickener | | 0.3 | 0.3 | 0.3 | 0.3 | 0.3 | 0.3 |
| Total | | 100.00 | 100.00 | 100.00 | 100.00 | 100.00 | 100.00 |
| mixing ratio PC:LC | | 1 | 1 | 1 | 1 | 1 | 1 |
| polymers [wt.-%] | in each case based | 27 | 27 | 27 | 27 | 27 | 27 |
| mineral binder | on the total mass of | 9.01 | 10.79 | 13.49 | 18.05 | 21.66 | 27.08 |
| [wt.-%] | the reactive liquid | | | | | | |
| ratio of wt.-% polymers | applied roof | 3.00 | 2.50 | 2.00 | 1.50 | 1.25 | 1.00 |
| to wt.-% mineral | waterproofing | | | | | | |
| binder | product | | | | | | |
| reinforcement | | No | No | No | No | No | No |
| non-woven | | | | | | | |
| proportion of PU | | 1% | 1% | 1% | 1% | 1% | 1% |
| polymer in total mass of | | | | | | | |
| polymers | | | | | | | |
| highest measured Tg | | −35 | −35 | −35 | −35 | −35 | −35 |
| according to DSC of | | | | | | | |
| the polymers used | | | | | | | |
| [° C.] | | | | | | | |
| Low temperature | | −30 | −25 | −25 | −25 | −20 | −20 |
| elasticity minimum | | | | | | | |
| temp. [° C.] | | | | | | | |
| Crack bridging | | −35 | −30 | −20 | −20 | −5 | −5 |
| (1.5 mm) minimum | | | | | | | |
| temp. [° C.] | | | | | | | |
| | | P19 | P20 | P21 | P22 | P23 | P24 |
| powder comp. [%] | | | | | | | |
| aluminate cement | mineral binder | 11.38 | 13.62 | 17.04 | 22.8 | 27.36 | 34.2 |
| Portland cement | system | 2.84 | 3.41 | 4.26 | 5.7 | 6.84 | 8.55 |
| calcium sulphate | | 3.79 | 4.54 | 5.68 | 7.6 | 9.12 | 11.4 |
| hemihydrate | | | | | | | |
| filler | fillers | 64.99 | 61.43 | 56.02 | 46.9 | 39.68 | 28.85 |
| light filler | | 16 | 16 | 16 | 16 | 16 | 16 |
| additives | additives | 1 | 1 | 1 | 1 | 1 | 1 |
| Total | | 100.00 | 100.00 | 100.00 | 100.00 | 100.00 | 100.00 |
| liquid comp. [%] | | | | | | | |
| acrylate polymer | polymer | 52.92 | 52.92 | 52.92 | 52.92 | 52.92 | 52.92 |
| PU polymer | dispersion(s) | 1.08 | 1.08 | 1.08 | 1.08 | 1.08 | 1.08 |
| water | | 45.5 | 45.5 | 45.5 | 45.5 | 45.5 | 45.5 |
| defoamer | additives | 0.2 | 0.2 | 0.2 | 0.2 | 0.2 | 0.2 |
| thickener | | 0.3 | 0.3 | 0.3 | 0.3 | 0.3 | 0.3 |
| Total | | 100.00 | 100.00 | 100.00 | 100.00 | 100.00 | 100.00 |
| mixing ratio PC:LC | | 1 | 1 | 1 | 1 | 1 | 1 |
| polymers [wt.-%] | in each case based | 27 | 27 | 27 | 27 | 27 | 27 |
| mineral binder | on the total mass of | 9.01 | 10.79 | 13.49 | 18.05 | 21.66 | 27.08 |
| [wt.-%] | the reactive liquid | | | | | | |
| ratio of wt.-% polymers | applied roof | 3.00 | 2.50 | 2.00 | 1.50 | 1.25 | 1.00 |
| to wt.-% mineral | waterproofing | | | | | | |
| binder | product | | | | | | |
| reinforcement | | No | No | No | No | No | No |
| non-woven | | | | | | | |
| proportion of PU | | 2% | 2% | 2% | 2% | 2% | 2% |
| polymer in total mass of | | | | | | | |
| polymers | | | | | | | |
| highest measured Tg | | −35 | −35 | −35 | −35 | −35 | −35 |
| according to DSC of | | | | | | | |
| the polymers used | | | | | | | |
| [° C.] | | | | | | | |
| Low temperature | | −30 | −25 | −25 | −25 | −20 | −20 |
| elasticity minimum | | | | | | | |
| temp. [° C.] | | | | | | | |
| Crack bridging | | −35 | −30 | −25 | −20 | −5 | −5 |
| (1.5 mm) minimum | | | | | | | |
| temp. [° C.] | | | | | | | |
| | | P25 | P26 | P27 | P28 | P29 | P30 |
| powder comp. [%] | | | | | | | |
| aluminate cement | mineral binder | 11.38 | 13.62 | 17.04 | 22.8 | 27.36 | 34.2 |
| Portland cement | system | 2.84 | 3.41 | 4.26 | 5.7 | 6.84 | 8.55 |
| calcium sulphate | | 3.79 | 4.54 | 5.68 | 7.6 | 9.12 | 11.4 |
| hemihydrate | | | | | | | |
| filler | fillers | 64.99 | 61.43 | 56.02 | 46.9 | 39.68 | 28.85 |
| light filler | | 16 | 16 | 16 | 16 | 16 | 16 |
| additives | additives | 1 | 1 | 1 | 1 | 1 | 1 |
| Total | | 100.00 | 100.00 | 100.00 | 100.00 | 100.00 | 100.00 |
| liquid comp. [%] | | | | | | | |
| acrylate polymer | polymer | 51.3 | 51.3 | 51.3 | 51.3 | 51.3 | 51.3 |
| PU polymer | dispersion(s) | 2.7 | 2.7 | 2.7 | 2.7 | 2.7 | 2.7 |
| water | | 45.5 | 45.5 | 45.5 | 45.5 | 45.5 | 45.5 |
| defoamer | additives | 0.2 | 0.2 | 0.2 | 0.2 | 0.2 | 0.2 |
| thickener | | 0.3 | 0.3 | 0.3 | 0.3 | 0.3 | 0.3 |
| Total | | 100.00 | 100.00 | 100.00 | 100.00 | 100.00 | 100.00 |
| mixing ratio PC:LC | | 1 | 1 | 1 | 1 | 1 | 1 |
| polymers [wt.-%] | in each case based | 27 | 27 | 27 | 27 | 27 | 27 |
| mineral binder | on the total mass of | 9.01 | 10.79 | 13.49 | 18.05 | 21.66 | 27.08 |
| [wt.-%] | the reactive liquid | | | | | | |
| ratio of wt.-% polymers | applied roof | 3.00 | 2.50 | 2.00 | 1.50 | 1.25 | 1.00 |
| to wt.-% mineral | waterproofing | | | | | | |
| binder | product | | | | | | |
| reinforcement | | No | No | No | No | No | No |
| non-woven | | | | | | | |
| proportion of PU | | 5% | 5% | 5% | 5% | 5% | 5% |
| polymer in total mass of | | | | | | | |
| polymers | | | | | | | |
| highest measured Tg | | −35 | −35 | −35 | −35 | −35 | −35 |
| according to DSC of | | | | | | | |
| the polymers used | | | | | | | |
| [° C.] | | | | | | | |
| Low temperature | | −35 | −30 | −25 | −25 | −20 | −20 |
| elasticity minimum | | | | | | | |
| temp. [° C.] | | | | | | | |
| Crack bridging | | −35 | −35 | −30 | −20 | −5 | −5 |
| (1.5 mm) minimum | | | | | | | |
| temp. [° C.] | | | | | | | |

| | | P31 | P32 | P33 | P34 | P35 |
|---|---|---|---|---|---|---|
| powder comp. [%] | | | | | | |
| aluminate cement | mineral binder | 11.38 | 13.62 | 17.04 | 22.8 | 27.36 |
| Portland cement | system | 2.84 | 3.41 | 4.26 | 5.7 | 6.84 |
| calcium sulphate | | 3.79 | 4.54 | 5.68 | 7.6 | 9.12 |
| hemihydrate | | | | | | |
| filler | fillers | 64.99 | 61.43 | 56.02 | 46.9 | 39.68 |
| light filler | | 16 | 16 | 16 | 16 | 16 |
| additives | additives | 1 | 1 | 1 | 1 | 1 |
| Total | | 100.00 | 100.00 | 100.00 | 100.00 | 100.00 |
| liquid comp. [%] | | | | | | |
| acrylate polymer | polymer | 48.17 | 48.17 | 48.17 | 48.17 | 48.17 |
| PU polymer | dispersion(s) | 0 | 0 | 0 | 0 | 0 |
| Natural rubber | | 5.83 | 5.83 | 5.83 | 5.83 | 5.83 |
| polymer | | | | | | |
| water | | 45.5 | 45.5 | 45.5 | 45.5 | 45.5 |
| defoamer | additives | 0.2 | 0.2 | 0.2 | 0.2 | 0.2 |
| thickener | | 0.3 | 0.3 | 0.3 | 0.3 | 0.3 |
| Total | | 100.00 | 100.00 | 100.00 | 100.00 | 100.00 |
| mixing ratio PC:LC | | 1 | 1 | 1 | 1 | 1 |
| polymers [wt.-%] | in each case based | 27 | 27 | 27 | 27 | 27 |
| mineral binder | on the total mass of | 9.01 | 10.79 | 13.49 | 18.05 | 21.66 |
| [wt.-%] | the reactive liquid | | | | | |
| ratio of wt.-% polymers | applied roof | 3.00 | 2.50 | 2.00 | 1.50 | 1.25 |
| to wt.-% mineral | waterproofing | | | | | |
| binder | product | | | | | |
| reinforcement | | No | No | No | No | No |
| non-woven | | | | | | |
| proportion of PU | | 0.0% | 0.0% | 0.0% | 0.0% | 0.0% |
| polymer in total mass of | | | | | | |
| polymers | | | | | | |
| highest measured Tg | | −35 | −35 | −35 | −35 | −35 |
| according to DSC of | | | | | | |
| the polymers used | | | | | | |
| Low temperature | | −35 | −30 | −20 | −5 | −5 |
| elasticity minimum | | | | | | |
| temp. [° C.] | | | | | | |
| Crack bridging | | −35 | −35 | −35 | −30 | −20 |
| (1.5 mm) minimum | | | | | | |
| temp. [° C.] | | | | | | |
| | | P36 | P37 | P38 | P39 | P40 |
| powder comp. [%] | | | | | | |
| aluminate cement | mineral binder | 11.38 | 11.38 | 11.38 | 11.38 | 11.38 |
| Portland cement | system | 2.84 | 2.84 | 2.84 | 2.84 | 2.84 |
| calcium sulphate | | 3.79 | 3.79 | 3.79 | 3.79 | 3.79 |
| hemihydrate | | | | | | |
| filler | fillers | 64.99 | 64.99 | 64.99 | 64.99 | 64.99 |
| light filler | | 16 | 16 | 16 | 16 | 16 |
| additives | additives | 1 | 1 | 1 | 1 | 1 |
| Total | | 100.00 | 100.00 | 100.00 | 100.00 | 100.00 |
| liquid comp. [%] | | | | | | |
| acrylate polymer | polymer | | | | 45.9 | 37.8 |
| acrylate polymer 2 | dispersion(s) | 53.46 | | | | |
| styrene acrylate | | | 53.46 | | | |
| polymer | | | | | | |
| acrylate polymer 3 | | | | 53.46 | | |
| PU polymer | | 0.54 | 0.54 | 0.54 | 2.7 | 5.4 |
| natural rubber | | 0 | 0 | 0 | 5.4 | 10.8 |
| polymer | | | | | | |
| water | | 45.5 | 45.5 | 45.5 | 45.5 | 45.5 |
| defoamer | additives | 0.2 | 0.2 | 0.2 | 0.2 | 0.2 |
| thickener | | 0.3 | 0.3 | 0.3 | 0.3 | 0.3 |
| Total | | 100.00 | 100.00 | 100.00 | 100.00 | 100.00 |
| mixing ratio PC:LC | | 1 | 1 | 1 | 1 | 1 |
| polymers [wt.-%] | in each case based | 27 | 27 | 27 | 27 | 27 |
| mineral binder | on the total mass of | 9.01 | 9.01 | 9.01 | 9.01 | 9.01 |
| [wt.-%] | the reactive liquid | | | | | |
| ratio of wt.-% polymers | applied roof | 3.00 | 3.00 | 3.00 | 3.00 | 3.00 |
| to wt.-% mineral | waterproofing | | | | | |
| binder | product | | | | | |
| reinforcement | | No | No | No | No | No |
| non-woven | | | | | | |
| proportion of PU | | 1% | 1% | 1% | 5% | 10% |
| polymer in total mass of | | | | | | |
| polymers | | | | | | |
| highest measured Tg | | −55 | −30 | −27 | −35 | −35 |
| according to DSC of | | | | | | |
| the polymers used | | | | | | |
| [° C.] | | | | | | |
| Low temperature | | −35 | −25 | −20 | −35 | −35 |
| elasticity minimum | | | | | | |
| temp. [° C.] | | | | | | |
| Crack bridging | | −35 | −20 | −20 | −35 | −35 |
| (1.5 mm) minimum | | | | | | |
| temp. [° C.] | | | | | | |

| | | P41 | P42 | P43 | P44 |
|---|---|---|---|---|---|
| powder comp. [%] | | | | | |
| aluminate cement | mineral binder | 11.38 | 11.38 | 11.38 | 11.38 |
| Portland cement | system | 2.84 | 2.84 | 2.84 | 2.84 |
| calcium sulphate | | 3.79 | 3.79 | 3.79 | 3.79 |
| hemihydrate | | | | | |
| filler | fillers | 64.99 | 64.99 | 64.99 | 64.99 |
| light filler | | 16 | 16 | 16 | 16 |
| additives | additives | 1 | 1 | 1 | 1 |
| Total | | 100.00 | 100.00 | 100.00 | 100.00 |
| liquid comp. [%] | | | | | |
| acrylate polymer | polymer | 48.6 | 45.9 | 43.2 | 37.8 |
| acrylate polymer 2 | dispersion(s) | | | | |
| styrene acrylate | | | | | |
| polymer | | | | | |
| acrylate polymer 3 | | | | | |
| PU polymer | | 5.4 | 8.1 | 10.8 | 16.2 |
| natural rubber | | 0 | 0 | 0 | 0 |
| polymer | | | | | |
| water | | 45.5 | 45.5 | 45.5 | 45.5 |
| defoamer | additives | 0.2 | 0.2 | 0.2 | 0.2 |
| thickener | | 0.3 | 0.3 | 0.3 | 0.3 |
| Total | | 100.00 | 100.00 | 100.00 | 100.00 |
| mixing ratio PC:LC | | 1 | 1 | 1 | 1 |
| polymers [wt.-%] | in each case based | 27 | 27 | 27 | 27 |
| mineral binder | on the total mass of | 9.01 | 9.01 | 9.01 | 9.01 |
| [wt.-%] | the reactive liquid | | | | |
| ratio of wt.-% polymers | applied roof | 3.00 | 3.00 | 3.00 | 3.00 |
| to wt.-% mineral | waterproofing | | | | |
| binder | product | | | | |
| reinforcement | | No | No | No | No |
| non-woven | | | | | |
| proportion of PU | | 10% | 15% | 20% | 30% |
| polymer in total mass of | | | | | |
| polymers | | | | | |
| highest measured Tg | | −35 | −35 | −35 | −35 |
| according to DSC of | | | | | |
| the polymers used | | | | | |
| [° C.] | | | | | |
| Low temperature | | −35 | −35 | −35 | −35 |
| elasticity minimum | | | | | |
| temp. [° C.] | | | | | |
| Crack bridging | | −35 | −35 | −35 | −35 |
| (1.5 mm) minimum | | | | | |
| temp. [° C.] | | | | | |

### Preparation of the Samples

6 compositions of reactive liquid applied roofing membranes were produced by mixing a liquid component containing acrylate polymer with a powder component, the proportion of polymer in relation to the proportion of mineral binder being varied in terms of wt.-% by successively reducing the proportion of filler and correspondingly increasing the proportion of mineral binder, resulting in the ratios of wt.-% polymer to wt.-% mineral binder shown in Table 1 for P1-P6. The indication of wt.-% refers to the respective ratio to the total mass of the reactive liquid applied roofing membrane.

From each of these 6 compositions, a further sample mixture was produced in each case, in which a non-woven was embedded. The samples are referred to as P7-P12. When embedding the non-woven, care was taken to ensure that the non-woven was embedded in the reactive liquid applied building material over the entire surface and free of bubbles.

Furthermore, 6 compositions each of reactive liquid applied roof waterproofing product were produced by mixing a liquid component with a powder component having a composition derived from P1-P6, the proportion of PU polymer relative to the mass of the liquid component being 1%, 2% and 5%, and relative to the total mass of the polymers being 1.9%, 3.7% and 9.4%. In the process, a corresponding acrylate polymer was substituted by the proportion of PU polymer. The samples are referred to as P13-P30.

Furthermore, 5 compositions of reactive liquid applied roof waterproofing products were produced by mixing a liquid component with a powder component having a composition derived from P1-P5, part of the acrylate polymer being replaced by conditioned natural latex. The samples are referred to as P31-P35.

Samples P36-P40 differ from the previous samples by a changed composition of the polymer dispersion.

In sample P36 an acrylate polymer with a T_{g}=−55° C. (acrylate polymer 2) was used. In sample P37 a styrene acrylate polymer with a T_{g}=−30° C. (styrene acrylate polymer) was used. In sample P38 an acrylate polymer with a T_{g}=−27° C. (acrylate polymer 3) was used.

In samples P39 and P40, the polymer dispersions are mixtures of acrylate polymer, PU polymer and natural rubber polymer, in particular with varying PU content.

In samples P41-P44, the proportion of PU polymer in the polymer mixture used is progressively increased from 10-30%.

As a comparative example, a composition of a commercially available waterproofing product (Ref 1) was used, which is composed according to DE 20 2005 015 351 U1 and has, among other things, a polymer content of 1.58 times the content of mineral binder.

As a further comparative example (Ref 2), a composition of the applicant available under the trade name MB TX 2K was used, which has a polymer content of less than 1.5 times the content of mineral binder, namely 1.25 times.

Finally, as a further comparative example (Ref 3), a composition of the applicant available under the trade name MB 2K+ was used, which has a polymer content of less than 2 times the content of mineral binder, namely 1.65 times.

In addition, two mixtures were prepared analogous to examples 1, 2 and 3 of WO 2012/038099 A1 (Ref 4, Ref 5 and Ref 6). The examples Ref 4, Ref 5 and Ref 6 were produced according to the teaching described therein. Ref 10 had a polymer content of 2.5 times the content of mineral binder. Ref 11

had a polymer content of 1.8 times the content of mineral binder. Ref 12 had a polymer content of 1.5 times the content of mineral binder.

The mixing of the components was carried out in all examples and comparative examples in such a way that the mixture was free of lumps at the end of the mixing process.

The investigated layer thicknesses were all between 1.9 mm and 2.3 mm.

| | | Ratio polymer/ |
|---|---|---|
| Sample no. | Composition | min. binder |
| Ref 1 | Commercially available product | 1.25 |
| Ref 2 | MB TX 2K | 1.25 |
| Ref 3 | MB2K+ | 1.65 |
| Ref 4 | Example 1 from WO 2021/038099 | 2.5 |
| | A1 | |
| Ref 5 | Example 2 from WO 2021/038099 | 1.8 |
| | A1 | |
| Ref 6 | Example 3 from WO 2021/038099 | 1.5 |
| | A1 | |

### Crack Bridging Test

The reactive roof waterproofing product of the samples P1-P44 and Ref 1-Ref 6 were each applied to two mortar prisms (16×4×4 cm³), hereinafter referred to as concrete prisms, rigidly connected over a square base surface, in the minimum dry film thickness to one of the resulting rectangular double surfaces with a central joint (32×4 cm²) in such a way that the joint is covered and the concrete prisms are connected exclusively by the reactive roof waterproofing product after curing of the reactive roof waterproofing product. The reactive roof waterproofing products were left to cure for 28 days at 20° C. and 50% relative humidity.

The conditioning period of 28 days was selected on the basis of the internal tests and experience and on the common test principles PG-MDS/FPD (version: November 2016) for reactive waterproofing in the base area. These have been established as state-of-the-art technology for many years and thus represent a high degree of long-term reliability of the material properties.

The reactive roof waterproofing product was then stored in a cooling station in the outlined test setup (cf. FIG. 4) and cooled down to −30° C. After one hour of conditioning at −30° C., the crack between the concrete prisms was widened to 0.5 mm and the test setup was stored for one hour at −30° C. The crack between the concrete prisms was then widened to 1 mm and the test setup was stored for one hour at −30° C. The crack between the concrete prisms was then widened to 1.5 mm and the test setup was stored for at least one hour at −30° C. The test specimens were assessed by visually inspecting the reactive roof waterproofing product for failure as a sealant above the expanded crack between the concrete prisms, i.e. checking whether the reactive roof waterproofing product itself exhibited cracks. Cracks of >100 μm could be reliably identified.

The results after the 28-day conditioning are shown in FIG. 5.

For samples P1 and P2, crack bridging of up to 1.5 mm could be achieved for temperatures down to −30° C. For sample P1, crack bridging of up to 1.5 mm could also be achieved for temperatures down to −35° C. For sample P3, crack bridging of up to 1.5 mm could be achieved for temperatures down to −25° C. For sample P4, crack bridging of up to 1.5 mm could be achieved for temperatures down to −20° C.

For samples P5 and P6, no crack bridging of up to 1.5 mm could be achieved at temperatures below −5° C.

For samples P13 and P14, P19 and P20, P25, P26 and P27, P31 to P34, as well as P36, P39 and P40, crack bridging of up to 1.5 mm could be achieved for temperatures down to −30° C. For the samples P13, P19, P25 and P26, as well as P31-P33, as well as P36, P39 and P40, the crack bridging of up to 1.5 mm could also be achieved for temperatures down to −35° C. For sample P21, crack bridging of up to 1.5 mm could be achieved for temperatures down to −25° C.

For samples P15, P16, P22, P28, P35, P37 and P38, crack bridging of up to 1.5 mm could be achieved for temperatures down to −20° C.

For samples P41-P44, crack bridging of up to 1.5 mm could be achieved for temperatures down to −35° C.

In comparison, no crack bridging of up to 1.5 mm could be achieved for the reference samples Ref 1, Ref 2, Ref 3, Ref 4, Ref 5 and Ref 6 at temperatures below −15° C.

In summary, it could be seen that the described properties of the reactive roof waterproofing product have a corresponding influence on crack bridging. For instance, irrespective of other properties, the crack bridging deteriorated with decreasing ratio of wt.-% polymer to wt.-% mineral binder. In addition, it was shown that only those examples containing exclusively polymers with measured T_{g} of less than −20° C. fulfilled the requirement for crack bridging at low temperatures. For example, the reference samples Ref 1-Ref 6 do not have a correspondingly low measured T_{g} of the polymers and could not achieve the crack bridging of 1.5 mm at temperatures below −20° C.

Furthermore, it could be shown that a proportion of 5% PU polymer and more, based on the total mass of polymers, improved the crack bridging properties for sample P27 compared to the corresponding samples P15 and P21 with the same ratio of binder to polymer.

### Low Temperature Flexibility Test

The flexibility test is based on the test of cold bending behaviour according to DIN 52123, version 08/1985.

The reactive roof sealant of samples P1-P44 and Ref 1 to Ref 6 were also cooled to temperatures ranging from −10° C. to −35° C. in five-degree increments and bent over a cylinder with a diameter of 4 cm after 24 hours of storage in each case. The test specimens were assessed by visually inspecting the reactive roof waterproofing product for the formation of cracks. Cracks of >100 μm could be reliably identified.

The results for the 28-day conditioning are shown in FIG. 6.

Samples P1, P7, P8, P9, P13, P19, P25, P26, P31, P32, P36, P39 and P40 passed the test at least down to −30° C. Samples P2, P3, P4, P10, P11, P12, P14, P15, P16, P20, P21, P22, P27, P28 and P37 exhibited no cracks down to −25° C. Samples P5, P6, P17, P18 and P23, P24, P29, P30, P33, P35 and P38 exhibited no cracks down to −20° C.

The reference sample Ref 5 exhibited no cracks down to −15° C. Reference samples Ref 1, Ref 2, Ref 3, Ref 4 and Ref 6 exhibited cracks at temperatures above −15° C.

It was shown that the properties of the reactive liquid applied building material according to the invention with regard to low-temperature flexibility could be achieved without reinforcement or embedding of non-woven, fibres or fabric. Lower temperatures could be achieved by embedding non-woven or using PU, as samples P7, P25, P31, P39, P40, P41, P42, P43 and P44 show. For the low temperature flexibility, too, it is shown that both the ratio of wt.-% polymer to wt.-% mineral binder—wt.-% refers here to the total mass of the reactive roof waterproofing product—and the T_{g} of the polymers used play a decisive role.

### Tensile Properties Test

Test specimens of tensile bar type 1B, in accordance with DIN EN ISO 527-2, were produced from the reactive waterproofing product for testing the tensile properties in accordance with DIN EN ISO 527-1:2019-12 “Plastics—Determination of tensile properties” for samples P1 and P13. For this purpose, the reactive liquid roof waterproofing product was applied to a glass plate (30×60 cm) coated with Teflon film in a layer thickness of 2.4 mm. After 28 days of conditioning at standard conditions, the

test specimens were prepared from the films obtained. The tensile properties were tested on a zwickiLine D0731920 according to standard specifications. The results are shown in FIG. 7.

It was found that sample P13 (2.2 N/mm²) achieved a tensile stress more than 70% higher than sample P1 (1.24 N/mm²), while the elongation at maximum stress decreased by approximately 13% from 49.4% (P1) to 42.8% (P13). Consequently, even a small proportion of PU polymer in the total amount of polymer in the reactive roof waterproofing product produces a significant increase in the internal stress of the system with negligible reduction in elongation at maximum stress. Experience has shown that optimising reactive waterproofing systems with regard to maximum stress and elongation at maximum stress leads to an optimised crack bridging capability of the system. It therefore seems reasonable that the explicit addition of PU polymer results in an improvement of the reactive roofing membrane.

### Test According to ETAG 005

Further reactive roofing membranes according to P1 and P13 were produced and subjected to a test based on ETAG 005, the DIN 18531 based thereon and the German flat roof guideline according to the performance classes in ETAG 005.

The test parameters included in particular the crack-bridging capacity, the adhesion to various substrates and the ageing behaviour under heat, hot water and UV ageing, as well as in all cases ensuring the water-tightness of the waterproofing, so that the penetration of water into the substrates provided with the roofing membrane is prevented and in this way the substrates are protected from water damage.

The reactive roofing membranes according to P1 and P13 each passed the test with a rating of W3 after performance of the procedure specified in EOTA TR-008.

They were shown to bridge cracks up to at least 1.5 mm after performance of the procedure specified in EOTA TR-013.

Furthermore, a classification of BROOF T1 according to DIN EN 13501-5:2016-12 was successfully carried out.

### Visualisation of the Reaction Process

FIGS. 8-13 show the results of microscopic and spectroscopic measurements on a reactive membrane according to P1.

After mixing the liquid component and the powder component, the sample was broken in the middle at different times. The fracture edge was examined in each case with a cryo-REM (scanning electron microscope) and with the aid of energy dispersive X-ray spectroscopy (EDX). FIGS. 8-10 refer to a time of 75 minutes after mixing. FIGS. 11-13 refer to a time of 285 minutes after mixing.

In FIG. 8, an inorganic phase with a flat, angular structure can be seen in the circle with the number “1”, which represents incompletely reacted hemihydrate. In the circle with the number “2”, a foam-like phase can be seen, which represents the coalescence of polymer spheres. The flat and foam-like structures are still separated from each other at this point.

FIG. 9 shows the energy dispersive X-ray spectroscopy (EDX) analysis of area “1” in FIG. 8. The spectrogram essentially shows 6 peaks. Two of the peaks can be attributed to the element platinum, which was applied for the purpose of carrying out the cryo-REM recording. The other peaks correspond to the elements carbon, oxygen, sulphur and calcium. With the exception of carbon (originating from the organic phase), these elements are essentially associated with the sulphate carrier of the mineral bonding system. The absence of aluminium indicates that it cannot be ettringite. The flat structure in “1” is therefore probably unreacted hemihydrate.

FIG. 10 shows the energy dispersive X-ray spectroscopy analysis of region “2” in FIG. 8. The spectrogram essentially shows 4 peaks. Two of the peaks can be attributed to platinum, which was applied for the purpose of carrying out the cryo-REM recording. The other peaks correspond to the elements carbon and oxygen. These elements can be attributed to the acrylate polymer, which forms cohesive, initially foam-like, later film-like cross-linked structures.

In FIGS. 11 and 12, the sample is shown at a later time of curing. The now formed ettringite is shown in FIG. 11 in the form of cluster-shaped star-like structures, each of which is formed from hexagonal needles. The ettringite is completely embedded in the polymer matrix. FIG. 12 shows again more clearly the hexagonal cross-section of an ettringite needle resulting from the hexagonal crystal system, which penetrates the polymer matrix.

FIG. 13 shows the energy dispersive X-ray spectroscopy analysis of region “3” in FIG. 11. The spectrogram essentially shows 7 peaks here. In addition to the peaks present in FIG. 9, the K-alpha line of the aluminium can be seen here at 1.49 keV. The presence of aluminium shows that it is the reaction product ettringite.

### Measurement of the Curing Speed

To measure the curing speed, the IP-8 Ultrasonic Multiplexer Tester V6 device from Ultratest was used.

FIG. 14 shows ultrasound measurements carried out on samples corresponding to P1, P25, P41, P42, P43 and P44. In these samples, the PU content varies. P1 has no PU, in P25 the proportion of PU is 5%, in P41 the proportion of PU is 10%, in P42 the proportion of PU is 15%, in P43 the proportion of PU is 20% and in P44 the proportion of PU is 30%.

In the present test, the samples were mixed and immediately poured into a measuring container, each measuring 2 cm in width, 6 cm in length and 5 cm in height, without air inclusions. From the centre of the side, an ultrasonic transmitter sent pulses across the curing sample at time intervals of 1 minute. Opposite the transmitter, the pulses were detected by an ultrasonic receiver. The speed of the ultrasound signal was determined in each case.

Conclusions about the curing speed can be drawn from the present test setup. In uncured, still liquid samples, an ultrasound signal can only propagate slowly. The transit speed of the ultrasound signal only increases when hardening begins.

While for P1 and P25 an increase in transit speed was already observed after approx. 110 minutes, with a comparatively slower increase in transit speed observed for P25, this was only the case for P41 and P42 after approx. 300 minutes. In addition, an even further slowed increase in transit speed was observed for P41 and P42 compared to P1 and P25. For P43 and P44, the increase was observed only after approx. 450 minutes. For P44, the increase in transit speed was almost unobservable.

From the results it could be concluded that an increase in the PU content of the polymer composition results in both a delay and a slowing of the curing process.

As a result, samples with a PU content of more than 20% are no longer suitable for reactive roof sealing in practice due to the late onset and slow curing. On the other hand, for samples with less than 20%, preferably less than 15% PU content, curing starts sufficiently early so that the advantages described above for using a PU content outweigh the disadvantages.

The invention is not limited to the embodiments described herein and includes a variety of other alternatives which are within the skill and knowledge of the person skilled in the art.

1. Use of a reactive liquid applied roof waterproofing product for producing a roofing membrane, the reactive liquid applied roof waterproofing product having a liquid component and a powder component,
the powder component comprising a mineral binder system consisting of a plurality of mineral binders capable of forming an ettringite phase in combination and the liquid component comprising one or more aqueous polymer dispersions,
the reactive liquid applied roof waterproofing product comprising, in the liquid component,

| | wt.-% | preferably wt.-% |
|---|---|---|
| polymer | 30-70 | 50-60 |

where the specification refers to the solids content of polymers in the polymer dispersion and the specification of weight percent refers to the weight of the liquid component,
a proportion of a PU polymer being at most 30% of the solids content of polymers, based on the total mass of the polymers,
characterized in that the reactive waterproofing product contains at least 2 times, preferably at least 2.5 times, in particular at least 3 times as much weight percent solids content of polymers as weight percent mineral binder, and at most 5 times as much weight percent solids content of polymers as weight percent mineral binder, where the specification of weight percent refers to the weight of the reactive liquid applied waterproofing product,
and the at least 80 wt.-% of the polymers used, based on the total mass of the polymers, has a glass transition temperature T_{g} of less than −20° C., preferably less than −30° C.,
the glass transition temperature T_{g} of a polymer sample being determined by means of differential scanning calorimetry (DSC, DIN EN ISO 11357-2:2014-07 “Plastics Differential scanning calorimetry (DSC)—Part 2: Determination of glass transition temperature and glass transition step height (ISO 11357-2:2013), German version EN ISO 11357-2:2014”).

2. Use according to claim 1,
characterized in that at least 90% by weight, preferably 100% by weight of the polymers used, based on the total mass of the polymers, have a glass transition temperature T_{g} of less than −20° C., preferably less than −30° C.

3. Use according to claim 1,
characterized in that the proportion of the PU polymer is not more than 20%, preferably not more than 15% of the solids content of polymers, based on the total mass of the polymers.

4. Use according to claim 1,
characterized in that the reactive liquid applied building material contains, in the powder component,

| | wt.-% | preferably wt.-% |
|---|---|---|
| mineral binder | 10-30 | 15-20 |

where the specification of weight percent refers to the weight of the reactive liquid applied waterproofing product.

5. Use according to claim 1,
characterized in that at least one of the polymers is based on one or more monomers of the group comprising (meth)acrylates, acrylonitrile, isocyanate, polyols, or a combination thereof, or contains conditioned natural latex.

6. Use according to claim 1
characterized in that at least one of the polymers is based on pure acrylate, conditioned natural latex or polyurethane.

7. Use according to claim 1,
characterized in that the aqueous polymer dispersion contains two or more polymers, preferably (meth)acrylate polymer and polyurethane or (meth)acrylate polymer and conditioned natural latex.

8. Use according to claim 1,
characterized in that the polymer dispersions have a minimum film forming temperature according to DIN 53787:02-74 of 0° C.

9. Roofing membrane, prepared by mixing a liquid component and a powder component, the powder component comprising a mineral binder system consisting of a plurality of mineral binders capable of forming an ettringite phase in combination and the liquid component comprising one or more aqueous polymer dispersions,
a proportion of a PU polymer being at most 30% of the solids content of polymers, based on the total mass of the polymers,
characterized in that the roofing membrane contains at least 2 times, preferably at least 2.5 times, in particular at least 3 times as much weight percent solids content of polymers as weight percent mineral binder, and at most 5 times as much weight percent solids content of polymers as weight percent mineral binder, where the specification of weight percent refers to the weight of the reactive waterproofing product,
and that at least 80 wt.-% of the polymers used, based on the total mass of the polymers, have a glass transition temperature T_{g} of less than −20° C., preferably less than −30° C.,
the glass transition temperature T_{g} of a polymer sample being determined by means of differential scanning calorimetry (DSC, DIN EN ISO 11357-2:2014-07 “Plastics—Differential scanning calorimetry (DSC)—Part 2: Determination of glass transition temperature and glass transition step height (ISO 11357-2:2013), German version EN ISO 11357-2:2014”),
the roofing membrane in a cured state at temperatures up to at least TL3, preferably TL4, according to ETAG 005, Part 1, being flexible with a classification W3 after performing a process specified in EOTA TR-008 and crack bridging for cracks up to at least 1.5 mm after performing a process specified in EOTA TR-013.

10. Roofing membrane according to claim 9,
characterized in that the roofing membrane in a cured state at temperatures up to at least TL3, preferably TL4, according to ETAG 005, Part 1, is designed to be shock-resistant with a classification P4 after performing a process specified in EOTA TR-006.

11. Roofing membrane according to claim 9,
characterized in that the roofing membrane in a cured state at temperatures up to at least TH4 according to ETAG 005, Part 1, is designed to be shock-resistant with a classification P4 after performing a process specified in EOTA TR-007.

12. Roofing membrane according to claim 9,
characterized in that the roofing membrane in a cured state at temperatures up to at least TL3, preferably TL4, is flexible after a test based on cold bending behaviour according to DIN 52123, as described in the description.

13.-15. (canceled)
